(19) United States
(12) Patent Application Publication
(10) Pub. No.: US 2010/0169589 A1
(43) Pub. Date: Jul. 1, 2010

(54) Redundant storage system using dual-ported drives

(76) Inventor: Bahman Jalali, San Diego, CA (US)

Correspondence Address: DON E. ERICKSON, STE. 104 627, 7668 EL CAMINO REAL, CARLSBAD, CA, 92009, US

(21) Appl. No.: 12/317,675

(22) Filed: Dec. 29, 2008

(51) Int. Cl. G06F 13/28; G06F 15/16

(52) U.S. Cl. 711/162; 709/212; 711/E12.103

(57) ABSTRACT

The present invention is an apparatus for providing redundant internet protocol (IP) storage. The apparatus includes an ethernet connection for connecting a plurality of users to a network having at least a first computer and a second computer, each computer having pre-boot software that controls whether the operating system is active or on standby, and wherein the pre-boot software of the first computer allows the operating system to be active and the pre-boot software of the second computer maintains the operating system on standby. Each computer is capable of running an operating system, and each computer includes a storage volume wherein each storage volume has dual ports and wherein the contents of the storage volume of the first computer is simultaneously mirrored to the storage volume of the second computer.

This application is based on Provisional Patent Application No. 61/009,772 filed on Jan. 3, 2008.

### FIELD OF THE INVENTION

The present invention relates in general to the field of redundant storage systems, and particularly to the efficient and simultaneous mirroring of operating systems and data on Serial Attached SCSI volumes.

### BACKGROUND OF THE INVENTION

Methods for the storage of digital files, documents, pictures, images and other data are well known. In connection with the electronic storage of data, systems incorporating more than one storage device have been devised. Using a number of storage devices in a coordinated fashion in order to store data can increase the total storage volume of the system. In addition, data can be distributed across the multiple storage devices such that data will not be irretrievably lost if one of the storage devices (or in some cases more than one storage device) fails. Examples of systems that can provide such advantages can be found in the various RAID (redundant array of independent disks) levels that have been developed.

U.S. Pat. No. 7,418,621 is directed to a storage system utilizing a number of storage devices that provides fault tolerance and improved input/output (IO) performance as compared to conventional mirrored storage arrangements. A storage system in accordance with the teachings of that patent includes two or more data storage devices, such as hard disk drives.

Data is stored on the storage devices in strips or chunks. In addition, the chunks of data stored in the system are distributed among the storage devices such that each storage device contains chunks comprising primary copies of data and chunks comprising secondary or mirrored copies of data. Furthermore, the primary and mirrored chunks of data are distributed among the storage devices such that each primary chunk of data is stored on a different physical storage device than the mirrored copy of that chunk of data. In accordance with still other embodiments of the present invention the chunks of data may be stored in strips having a size corresponding to a defined data chunk size such that a stripe of data across all of the storage devices and corresponding to a first strip on those storage devices contains a primary copy of data. A next strip on each of the storage devices comprising a next stripe across all of the storage devices contains a mirrored copy of the data stored in the preceding stripe, but arranged such that the primary and mirrored copies of any one chunk of data exist on different storage devices.

However, the storage system described has many limitations, particularly in the area of Ethernet systems. Hardware failures in computer system could cause the whole system go to down. Hardware failures in the disk drive controllers could cause data storage to fail, whether writing the primary data or a mirror thereof. The present invention is intended to address these problems.

### SUMMARY OF THE INVENTION

The present invention is directed to a redundant storage system whereby the changes to the operating system, programs, and the data of a first computer are simultaneously copied, or mirrored to a stand-by system by means of dual-port Serial Attached SCSI volumes.

### BRIEF DESCRIPTION OF THE DRAWINGS

FIG. 1 is a block diagram of the invention.

### DETAILED DESCRIPTION OF THE INVENTION

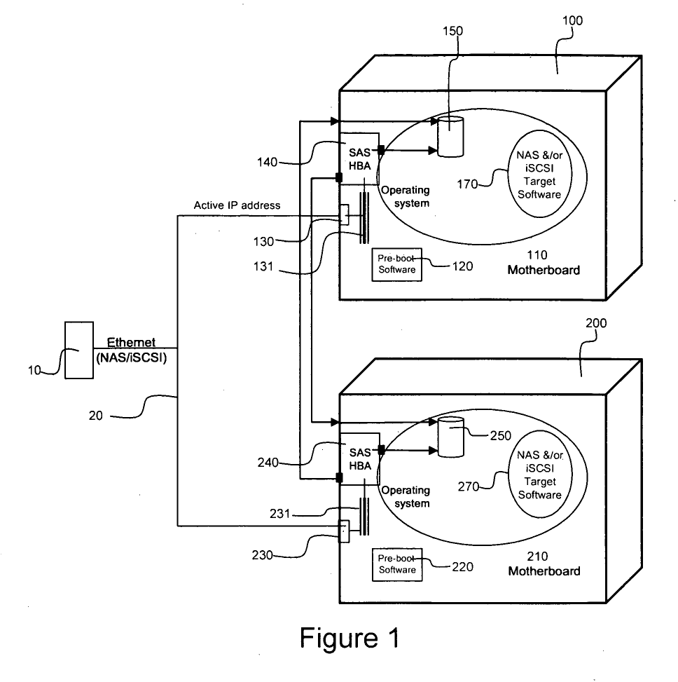

The redundant internet protocol (IP) storage/server can be described as shown in FIG. 1. Server 10 is a computer in a network that is used to provide services (as access to files or shared peripherals or the routing of e-mail) to other computers in the network. Server 10 may also be iSCSI initiators or NAS clients. SCSI is Small Computer System Interface, and iSCSI is internet SCSI, which is a proposed transport protocol for SCSI that operates on top of Computing Transmission Control Protocol (TCP), transport layer protocol (L4) that is one of the core protocols of the internet protocol. A local area network site is assigned an active IP address.

Server 10 is connected through an Ethernet connection in parallel to two identical computers, 100 and 200 by means of Ethernet ports 130 and 230 respectively. Server 10 could be a NAS client or an iSCSI initiator. In normal conditions users (Network Attached Storage (NAS) clients and iSCSI initiators)) are connected to the active computer and storage is being served to those clients and initiators from the active computer. iSCSI initiators are the servers who access the iSCSI targets, a device on iSCSI networks that acts as a target or storage. iSCSI targets are block based storage interface. iSCSI software drivers on each computer/server is also called iSCSI initiator.

Ethernet is a computer network architecture consisting of various specified local-area network protocols, devices, and connection methods. Each computer 100 and 200 has a motherboard 110 and 210 respectively, and runs an operating system (OS). Ethernet ports 130 and 230 are on their respective motherboards 110 and 210 and there are PCI busses 131 and 213 respectively to which ethernet ports 130 and 230 are connected. SAS Raid host bus adapter (HBA) 140 and 240 plug into the motherboard PCI slot also. They are not physically connected to each other, but operating system can access both Ethernet port and SAS Raid HBA through PCI slots.

The operating systems for computers 100 and 200 are identical. As in any computer, programs are loaded to the computer during what is called an initial program load (IPL), typically called “booting” the system. An example of a pre-boot software is an EFI BIOS software program, or a Linux based software program, a virtualization software that houses the main OS in a virtual machine, or any program of that sort. In the instant invention, there are parallel pre-boot software 120 and 220, which monitor the booting of their respective systems. When initially booting the systems, the first to pre-boot system will recognize that there is no active software running, and will allow computer 100 to completely boot its operating system, permitting it to go into the active mode. Pre-boot software 220 will detect that computer 100 is active, and will go into a standby polling mode, not allowing computer 200 to boot up. Pre-boot software 220 will then sit in its pre-boot mode, and continuously poll computer 100 to determine if it remains in active mode. A mirror of the all volumes including the OS will be made in active computer 100 after IPL and during initial configuration or installation. Active computer 100 SAS drive 150 will be mirrored to standby computer 200 SAS drive 250. It is not necessary that the OS be active on the standby computer 200, since the SAS drives, or volume, are dual ported. The dual port disk drive interface circuit enables a plurality of dual port disk drives to be interconnected with a plurality of control units in a manner that is transparent to both the dual port disk drives and the control unit. SAS volumes 150 and 250 could also be a SAS redundant array of inexpensive disks (Raid). Raid is a technology that employs the simultaneous use of two or more hard disk drives to achieve greater levels of performance, reliability, and/or larger data volume sizes. When several physical disks are set up to use Raid technology, they are said to be in a Raid array. This array distributes data across several disks, but the array is seen by the computer user and operating system as one single disk (or volume). Raid can be set up to serve several different purposes. In data storage, storage computers usually use Raid technology to combine a plurality of disks into one big volume and some Raid types also provide protection against disk failures. For example In Raid-5, if one disk dies the remaining volume still is accessible without problems

The active computer serial attached SCSI (SAS) Raid host bus adapter (HBA) 140 has access to both its own internal volume 150 and also external volume 250 of the standby computer 200. When server 10 inputs a write command or operation to computer 100, it accesses SAS volume 150 and makes and identical mirror on SAS volume 250. So basically OS and data volumes in active computer 100 are mirrored to the drives of the standby computer 200. Therefore all the content of the OS and data volumes will be the same at all times in both computers. Mirroring can be initiated either by the SAS Raid HBAs or active operating system.

If active computer 100 dies for any reason, the standby computer pre-boot software 220 detects that active computer 100 is not responding anymore and initiates the boot of the main OS in standby computer 200. Since standby computer 200 has the exact copy of the OS and volumes of the active computer on SAS volume 250, it will boot up to the main OS and starts serving the clients exactly the same data as they were doing on computer 100, with computer 200 now becoming the active computer.

Each computer that is connected to Ethernet and is using TCPIP as its mode of communication has two identifiers: 1) a Media Access Control address (MAC address) which is in computer networking, an Ethernet Hardware Address (EHA), hardware address, adapter address or physical address is a quasi-unique_identifier assigned to most network adapters or network interface cards (NICs) by the manufacturer for identification. If assigned by the manufacturer, a MAC address usually encodes the manufacturer's registered identification number, and 2) an Internet Protocol (IP) address, which is a numerical identification (logical address) that is assigned to devices participating in a computer network utilizing the Internet Protocol for communication between its nodes. Although IP addresses are stored as binary numbers, they are usually displayed in human-readable notations, such as 208.77.188.166 (for IPv4), and 2001:db8:0:1234:0:567:1:1 (for IPv6). The role of the IP address has been characterized as follows: “A name indicates what we seek. An address indicates where it is. A route indicates how to get there.” Before OS boot in the standby computer 200, the pre-boot software 220 will change the configuration of the Ethernet port of the standby computer to have the same common IP address and also same common MAC address of the active computer. Because of this change, clients will not notice any change in storage access and will be able to continue to use data/storage as before.

When active computer 100 is repaired and powered up, pre-boot software program 120 will detect that there is already an active computer up and running, and will stay in the pre-boot software loop. This computer 100 will now act as the new standby computer. The role of pre-boot software is to make sure that the active computer gets the common IP address and common MAC address.

The combination of using dual ported SAS drives, mirroring the disks/volumes as described above, and new pre-boot software is new technology/design for creating a redundant IP storage which makes this invention unique.

While the present description contains much specificity, this should not be construed as limitations on the scope of the invention, but rather as examples of some preferred embodiments thereof. Accordingly, the scope of the invention should not be determined by the specific embodiments illustrated herein. The full scope of the invention is further illustrated by the claims appended hereto.

I claim:

1. An apparatus for providing redundant internet protocol (IP) storage comprising:
a. an ethernet connection for connecting a plurality of users to a network;
b. the network having at least a first computer and a second computer, each computer capable of running an operating system, and each computer including a storage volume;
c. each storage volume having dual ports; and wherein the contents of the storage volume of the first computer is mirrored to the storage volume of the second computer.

2. The apparatus of claim 1 wherein mirroring of the storage volume of the first computer to the storage volume of the second computer is simultaneous to any change in the contents of the storage volume of the first computer.

3. The apparatus of claim 1 wherein each computer has pre-boot software that controls whether the operating system is active or on standby.

4. The apparatus of claim 3 wherein the pre-boot software of the first computer allows the operating system to be active and the pre-boot software of the second computer maintains the operating system on standby.

5. The apparatus of claim 3 wherein the pre-boot software of the standby computer is capable of continuously polling the active computer to determine if the active computer remains active.

6. The apparatus of claim 5 wherein the pre-boot software of the standby system can detect when the active computer is no longer active, and wherein the pre-boot software can then allow the operating system of the standby computer to go active.

7. The apparatus of claim 1 wherein the active computer obtains a common IP address and Media Access Control (MAC) address upon becoming active.

8. The apparatus of claim 7 wherein the pre-boot software of the standby computer assigns the common IP address and MAC address to the standby computer when the standby computer becomes active.

9. The apparatus of claim 6 wherein the contents of the storage volume of the now active second computer is mirrored to the storage volume of the now standby first computer.

10. An apparatus for providing redundant internet protocol (IP) storage comprising:
a. an ethernet connection for connecting a plurality of users to a network;
b. the network having at least a first computer and a second computer, each computer having pre-boot software that controls whether the operating system is active or on standby, each computer capable of running an operating system, and each computer including a storage volume;
c. each storage volume having dual ports; and wherein the contents of the storage volume of the first computer is simultaneously mirrored to the storage volume of the second computer.

11. The apparatus of claim 10 wherein the pre-boot software of the first computer allows the operating system to be active and the pre-boot software of the second computer maintains the operating system on standby.

12. The apparatus of claim 11 wherein the pre-boot software of the standby computer is capable of continuously polling the active computer to determine if the active computer remains active.

13. The apparatus of claim 12 wherein the pre-boot software of the standby system can detect when the active computer is no longer active, and wherein the pre-boot software can then allow the operating system of the standby computer to go active.

14. The apparatus of claim 1 wherein the active computer obtains a common IP address upon becoming active.

15. The apparatus of claim 14 wherein the pre-boot software of the standby computer assigns the common IP address to the standby computer when the standby computer becomes active.

16. The apparatus of claim 13 wherein the contents of the storage volume of the now active second computer is mirrored to the storage volume of the now standby first computer.

17. An apparatus for providing redundant internet protocol (IP) storage comprising:
a. an ethernet connection for connecting a plurality of users to a network;
b. the network having at least a first computer and a second computer, each computer having pre-boot software that controls whether the operating system is active or on standby, wherein the pre-boot software of the first computer allows the operating system to be active and the pre-boot software of the second computer maintains the operating system on standby, and wherein the pre-boot software of the standby computer is capable of continuously polling the active computer to determine if the active computer remains active;
c. each computer capable of running an operating system, and each computer including a storage volume;
d. each storage volume having dual ports; and wherein the contents of the storage volume of the first computer is simultaneously mirrored to the storage volume of the second computer.

18. The apparatus of claim 17 wherein the pre-boot software of the standby system can detect when the active computer is no longer active, wherein the pre-boot software can then allow the operating system of the standby computer to go active, and wherein the contents of the storage volume of the now active second computer is mirrored to the storage volume of the now standby first computer.

19. The apparatus of claim 17 wherein the active computer obtains a common IP address and common MAC address upon becoming active.

20. The apparatus of claim 14 wherein the pre-boot software of the standby computer assigns the common IP address and common MAC address to the standby computer when the standby computer becomes active.
